(19) United States
(12) Patent Application Publication
(10) Pub. No.: US 2008/0061458 A1
(43) Pub. Date: Mar. 13, 2008

(54) Mold for forming lens of light emitting diode package and method of manufacturing light emitting diode package using the same

(75) Inventors: Young Sam Park, Seoul (KR); Hun Joo Hahm, Sungnam (KR); Seong Yeon Han, Gwangju (KR); Chul Hee Yoo, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD

(21) Appl. No.: 11/896,975

(22) Filed: Sep. 7, 2007

(30) Foreign Application Priority Data
Sep. 7, 2006 (KR) 10-2006-0086261

(51) Int. Cl. B29D 11/00; B28B 7/36

(52) U.S. Cl. 264/1.32; 249/115

(57) ABSTRACT

There is provided a mold formed of fluorocarbon resin to prevent a resin, which is a material of a lens of a LED package, from adhering to the mold even without using a separate release film, and a method of manufacturing the light emitting package using the mold. The mold includes a plurality of cavities formed in an upper surface thereof to hold a resin for forming lenses of the light emitting diode package. The mold and the method using the mold prevents adherence of the resin without using a separate release film, allowing formation of a lens with a smooth surface and formation of a protrusion or an indentation on the surface of the lens.

### CLAIM OF PRIORITY

This application claims the benefit of Korean Patent Application No. 2006-0086261 filed on Sep. 7, 2006, in the Korean Intellectual Property Office, the disclosure of which is incorporated herein by reference.

### BACKGROUND OF THE INVENTION

1. Field of the Invention

The present invention relates to a mold, for forming a lens, applied to a light emitting diode (LED) package and a method of manufacturing the LED package using the same, and more particularly, to a mold formed of fluorocarbon resin so that a resin, which is a material for a lens, does not adhere to the mold even without using a separate release film, and to a method of manufacturing the LED package using the same.

2. Description of the Related Art

Recently, liquid crystal displays (LCDs) are required to be produced in a large size in order to output large-capacity images. Since using a cold cathode fluorescent lamp for a light source of the LCD entails environmental restriction including spatial restriction and use of mercury, light emitting diodes (LEDs) which are easily miniaturized are widely used for the light source of LCD.

Such an LED is manufactured in a package in which current is supplied and the light is emitted at a certain angle. The LED package typically includes a substrate configured to enable current supply, an LED mounted on the substrate and a lens covering the LED.

There may be various methods of forming the lens in the LED package, but the most representative method entails immersing the LED in a liquid encapsulating material and curing the liquid encapsulating material.

A conventional method of manufacturing an LED package will now be described with reference to accompanying drawings.

In the conventional method, first, as shown in FIG. 1, a mold 30 having a plurality of cavities 32 formed therein and a substrate 20 having an LED chip 10 mounted therein are provided, and the substrate 20 is combined with the mold 30 such that each of the LED chips 10 resides in each of the cavities 32.

When the substrate 20 and the mold 30 are combined, a liquid resin 40, which is the material for the lens, is injected into the cavities 32 as shown in FIG. 2, and when the resin 40 is cured, the mold 30 is separated as shown in FIG. 3.

However, using such a conventional method of manufacturing the LED package, the resin 40 may adhere to the mold 30 due to its own adhesive property, so scratches may be formed on a surface of the resin 40 while separating the mold 30. When the scratches are formed on the surface of the resin 40, which is an element for functioning as a lens after it is cured, the light emitted from the LED chip 10 may not be evenly distributed with spots and the like, which results in a fatal problem.

Therefore, in order to solve such problems, there has been suggested a method in which a release film is provided between the resin 40 and the mold 30 so that the resin 40 does not adhere to the mold 30.

In the conventional method using the release film, as shown in FIG. 4, the release film 50 having non-adhesive property is provided on an upper surface of the mold 30, i.e., a surface of the mold to be in contact with the liquid resin 40 (see FIG. 3), thereby preventing the resin 40 from adhering to the mold 30. In this case, an operation of combining the substrate 20 with the mold 30, an operation of injecting the resin 40, and an operation of separating the mold 30 after the resin 40 is cured are identical to the operations in the embodiment illustrated in FIGS. 1 to 3, and thus no further description is provided.

The release film 50 is formed of a material having non-adhesive property so as not to adhere to the resin 40, thereby preventing the scratches from being formed on the surface of the resin 40 in the process of separating the mold 30 after the resin 30 injected into the cavity 32 is cured. Therefore, using such a release film 50 advantageously allows forming a lens with a smooth surface.

However, the release film 50 may be torn or deformed in the process of separating the mold 30 and thus is not suitable for reuse. Therefore, the release film 50 should be removed each time the mold 30 is separated when the resin is cured and a new release film 50 is attached on the mold 30 each time the resin 40 is injected, which problematically complicates the manufacturing process and increases the manufacturing cost.

In addition, when there is a need to form a protrusion or an indentation in the surface of the lens according to the use of the package, the same shape should be formed in an inner surface of the cavities 32 of the mold 30, in order for the lens and the mold to fit each other. In this case, the release film 50 attached to the inner surface of the cavity 32 makes the edge or the indentation less distinct, which makes it impossible to form the protrusion or indentation in the surface of the lens.

### SUMMARY OF THE INVENTION

An aspect of the present invention provides a mold for forming a lens of an LED package, the mold preventing adherence of a resin even without using a separate release film and allowing formation of a protrusion or an indentation in a surface of the lens, and a method of manufacturing the LED package using the mold.

According to an aspect of the invention, there is provided a mold for forming a lens of a light emitting diode package, the mold including: a plurality of cavities formed in an upper surface of the mold to hold a resin for forming lenses of the light emitting diode package, wherein one of the entirety of the mold and a portion of the mold including an inner surface of each of the cavities is formed of fluorocarbon resin to prevent the resin contained in the cavities from adhering to the mold.

The mold may be formed of a metallic material coated with fluorocarbon resin on one of the entire surface in which the cavities are formed and an inner surface of each of the cavities.

The fluorocarbon resin may be one selected from a group consisting of poly tetra fluoro ethylene (PTFE), tetrafluoroethylene-Hexafluoropropylene-copolymer (FEP) and tetrafluoroethylene-perfluoro(alkyl vinyl ether) copolymer (PFA).

Each of the cavities may have an uneven surface pattern formed on an inner surface thereof.

Each of the cavities may have a protrusion formed in a center of an inner surface thereof.

According to another aspect of the invention, there is provided a method of manufacturing a light emitting diode package, the method including: providing a substrate with a light emitting diode chip attached thereon; providing a mold for forming a lens of the light emitting diode package, wherein one of the entirety of the mold and a portion of the mold including an inner surface of each of the cavities is formed of fluorocarbon resin to prevent the resin contained in the cavities from adhering to the mold; seating the substrate on the mold and injecting a liquid resin, which is a material of the lens of the light emitting diode package, into the cavities of the mold; and separating the mold from the resin, the material of the lens of the light emitting diode package, and from the substrate after the resin is cured.

The mold may be formed of a metallic material coated with fluorocarbon resin on one of the entire surface in which the cavities are formed and an inner surface of each of the cavities.

The fluorocarbon resin may be one selected from a group consisting of poly tetra fluoro ethylene (PTFE), tetrafluoroethylene-Hexafluoropropylene-copolymer (FEP) and tetrafluoroethylene-perfluoro(alkyl vinyl ether) copolymer (PFA).

Each of the cavities may have an uneven surface pattern formed on an inner surface thereof.

Each of the cavities may have a protrusion formed in a center of an inner surface thereof.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 to 3 are views illustrating a conventional method of manufacturing an LED package;

FIG. 4 is a view illustrating a conventional method of manufacturing an LED package using a release film;

FIGS. 5 to 7 are views illustrating a method of manufacturing an LED package using a mold for forming the lens for the LED package according to an exemplary embodiment of the present invention;

FIG. 8 is a view illustrating a mold for forming the lens of an LED package according to another exemplary embodiment of the present invention;

FIG. 9 is a perspective view illustrating an LED package manufactured by the mold according to the another embodiment of the present invention; and

FIG. 10 is a view illustrating a mold for forming a lens of an LED package according to still another embodiment of the present invention.

### DETAILED DESCRIPTION OF THE PREFERRED EMBODIMENT

The following description will present a mold for forming a lens of a light emitting diode (LED) package and a method of manufacturing the LED package using the mold with reference to the accompanying drawings.

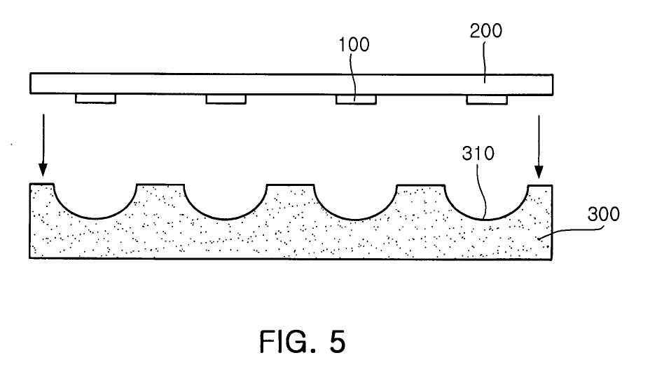

FIGS. 5 to 7 are diagrams illustrating a process of manufacturing an LED package using a mold 300, for forming a lens for an LED package, according to an exemplary embodiment of the present invention.

As shown in FIG. 5, the mold 300 is formed of fluorocarbon resin so that a resin 400, which is the material of the lens, i.e., epoxy, silicone, a mixture of epoxy and silicone and the like does not adhere to the mold 300. Also, the mold 300 has a plurality of cavities 310 formed in an upper surface thereof. That is, each of the cavities 310 is formed in an upper hemisphere shape with a gradually curved bottom surface, but the present invention is not limited thereto and the cavities 310 may be formed in various shapes according to the desired shape of the lens by the user.

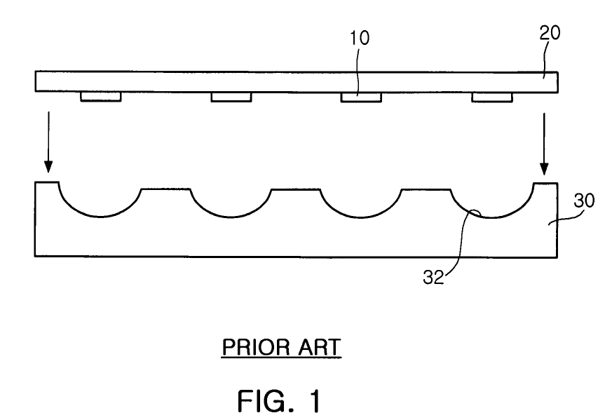

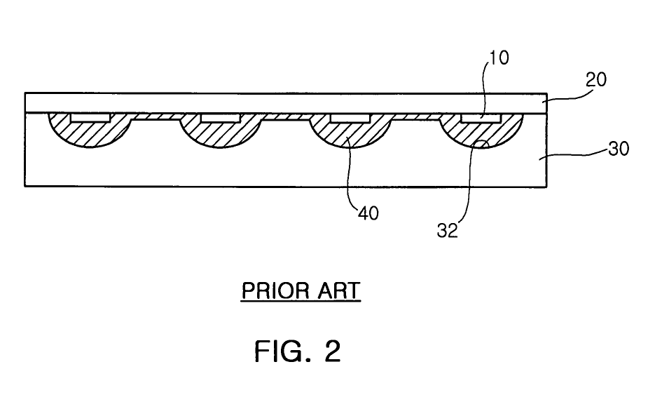

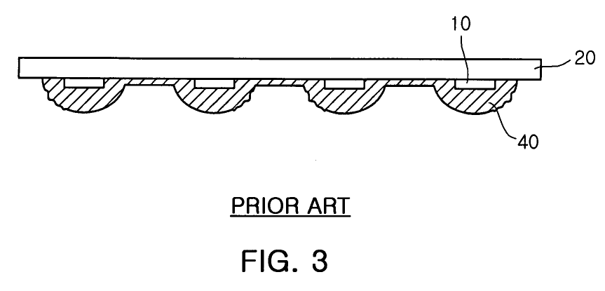

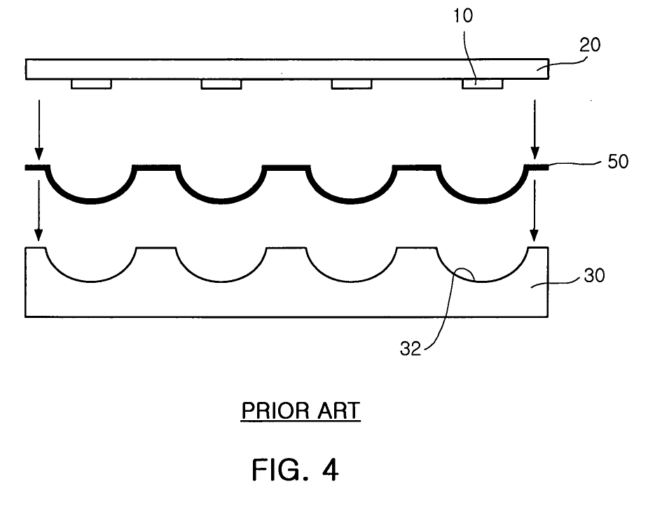

In this case, the functions of the cavity 310 are identical to those of the cavity 32 of the conventional mold shown in FIG. 1, and thus no further description is provided.

The fluorocarbon resin includes ethylene with at least one hydrogen atom substituted by fluorine and a synthetic resin 400 formed of polymerization of derivatives of the ethylene with at least one hydrogen atom substituted by fluorine. The fluorocarbon resin resists heat and chemicals and has such good electric insulating properties that it is used as an insulating material of packing, coating and electric devices. Also, the fluorocarbon resin has non-adhesive properties and such a low friction coefficient that it is utilized as a coating material of kitchen appliances. The fluorocarbon resin includes poly tetra fluoro ethylene (PTFE), tetrafluoroethylene-Hexafluoropropylene-copolymer (FEP), tetrafluoroethylene-perfluoro(alkyl vinyl ether) copolymer (PFA) and the like and is well known under the product name “Teflon” available from Dupont, U.S. PTFE is a crystalline polymer having a melting point of 327□ and a continuous operating temperature of 260□, and thus can be stably used in a high-temperature environment. In addition, it has such good chemical resistance that it does not react to various solvents of acidity or alkali, but reacts only under harsh conditions of special chemicals such as fluorocarbon gas, alkali metal, chlorine trifluoride and the like, and thus used for a material for gaskets, packing and sealing. The most distinct mechanical feature of PTFE is that it has such a small friction coefficient that it is used for various fillers and bearings for oil-less sliding materials. In addition, its non-adhesive property is widely utilized for the coating of frying pans and various steel tubes. In addition, PTFE has good electric characteristics, in particular, it has good dielectric characteristics and exhibits a stable and low dielectric ratio and a dissipation factor in wide frequency and temperature ranges.

Therefore, forming the mold 300 with PTFE according to the present invention prevents the resin 400 from adhering to the mold 300 and damage to the resin 400. Further, the mold 300 formed of PTFE has excellent wear resistance and a continuous operating temperature higher than the curing temperature (150□) of a general resin 400, thereby enabling continuous use of the mold for a long time at a high temperature.

FEP has a melting point of 250 to 295□ and a continuous operating temperature of 200□ and thus can be subject to injection molding and extrusion molding. In particular, FEP has a better non-adhesive property than PTFE while its other properties are similar to those of PTFE. Therefore, when FEP is used for the material of the mold for forming the lens of the LED package, it more securely prevents the resin 400 from adhering to the mold 300, in addition to yielding the above-described effects.

PFA has a melting point of 302 to 310□ and a continuous operating temperature of 260□ while its other characteristics are similar to those of PTFE. However, PFA has better durability than PTFE, and thus utilized for packing, valves, wafer baskets, bearings, electric wires, substrates 200 and the like. Therefore, forming the mold 300 with PFA advantageously increases the life of the mold.

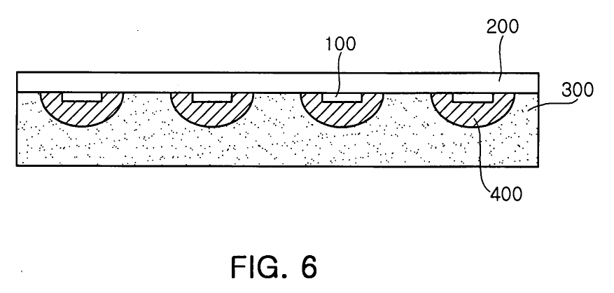

As shown in FIG. 6, the substrate 200 with the LED chip 100 mounted thereon is seated on the mold 300 formed of fluorocarbon resin and the liquid resin 400 is injected.

At this time, the resin 400 may be injected by dispensing an exact amount in each of the cavities 310. Alternatively, the inner space of each of the cavities 310 formed between the mold 300 and the substrate 200 may be made vacuum and the resin 400 may be injected to fill each of the inner spaces of the cavities 310.

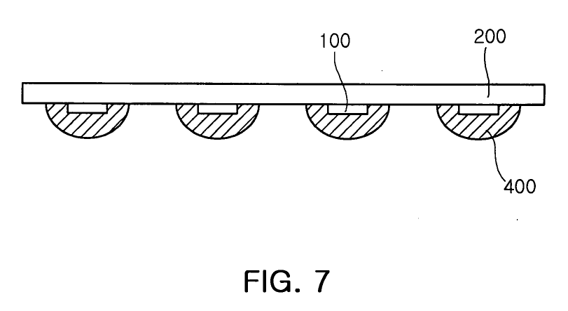

Then, when the injection is complete, the liquid resin 400 may be cured preliminarily at about a temperature of 150° C. for 600 seconds. After the resin 400 is cured preliminarily, the mold 300 is separated. Then, the resin 400 is completely cured in a separate oven, thereby forming the lenses covering the LED chips 100 as shown in FIG. 7.

In this case, as the resin 400 does not adhere to the mold 300, the lens is formed with a very smooth surface. In addition, using the mold 300 for forming the lens of the LED package according to the present invention, there is no need to use a separate release film, thereby reducing the manufacturing costs and simplifying the manufacturing process as operations of attaching and removing the release film are not required.

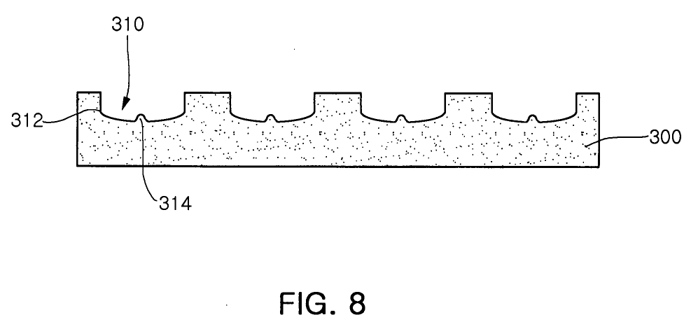

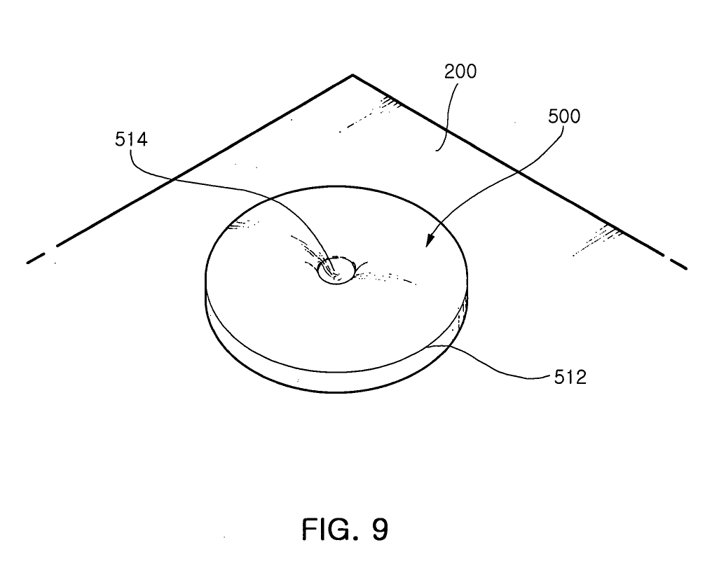

FIG. 8 is a perspective view illustrating a mold for forming a lens of an LED package according to another embodiment of the present invention, and FIG. 9 is a perspective view illustrating the LED package manufactured by the mold according to the another embodiment of the present invention.

Since no other component such as a release film is attached on an inner surface of the cavity 310, the lens is formed in the exact shape as the cavity 310 of the mold 300.

That is, by using the mold 300 according to the present invention, it is possible to manufacture an LED package 500 having a sharp outer edge 512 and an indentation 514 formed in a center thereof by a sharp edge 312 formed in an inner surface of the cavity 310 and a protrusion 314 formed in the center of the cavity 310.

In addition, by using the mold 300 according to the present invention, it is possible to manufacture an LED package having an uneven surface pattern or a sharp-edged protrusion or indentation formed in an outer surface thereof, in addition to the shape of the lens shown in FIG. 9.

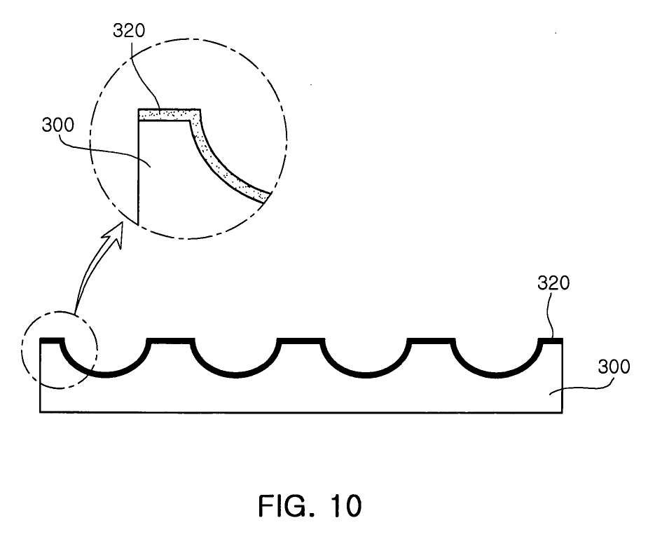

FIG. 10 is a view illustrating a mold for forming a lens of an LED package according to still another exemplary embodiment of the present invention.

The mold 300 for forming a lens of an LED package may be entirely formed of fluorocarbon resin as shown in FIG. 5. However, the mold may also be formed of a general metal coated with fluorocarbon resin only on one side thereof, the one side to be contacting the resin 400, i.e., a surface in which the cavities 310 are formed, as shown in FIG. 10.

The same effects as in the embodiments shown in FIGS. 5 to 7 are expected from forming a coating layer 320 of fluorocarbon resin only on one surface to be contacting the resin 400 as shown in FIG. 10, rather than forming the entire mold 300 with fluorocarbon resin.

In this case, the coating layer 320 of fluorocarbon resin may be formed thick enough so that it is not easily damaged after repeatedly using the mold 300. At the same time, the coating layer 320 may be formed thin enough so that it does not affect the delicate shape of the lens. Therefore, the coating layer 320 may be formed in various thicknesses under the above-described conditions, depending on the needs.

In this case, the method of coating the fluorocarbon resin on the mold of metallic material is identical to a method of coating fluorocarbon resin on kitchen appliances or mechanical components such as bearings, and therefore additional description is not provided.

When the coating layer 320 of fluorocarbon resin is formed only on one surface in which the cavities 310 are formed, as described above, the mold has a greater strength than the mold entirely formed of fluorocarbon resin. Also, the mold 30 shown in FIG. 1 can be recycled, increasing the utility of resources.

By employing the mold and the method of manufacturing the LED package using the mold according to the present invention, the resin does not adhere to the mold even without using a separate release film, thereby allowing formation of a lens with a smooth surface and also with a protrusion or an indentation formed in a surface of the lens.

While the present invention has been shown and described in connection with the exemplary embodiments, it will be apparent to those skilled in the art that modifications and variations may be made without departing from the spirit and scope of the invention as defined by the appended claims.

What is claimed is:

1. A mold for forming a lens of a light emitting diode package, the mold comprising:
a plurality of cavities formed in an upper surface of the mold to hold a resin for forming lenses of the light emitting diode package,
wherein one of the entirety of the mold and a portion of the mold including an inner surface of each of the cavities is formed of fluorocarbon resin to prevent the resin contained in the cavities from adhering to the mold.

2. The mold of claim 1, wherein the mold is formed of a metallic material coated with fluorocarbon resin on one of the entire surface in which the cavities are formed and an inner surface of each of the cavities.

3. The mold of claim 1, wherein the fluorocarbon resin is one selected from a group consisting of poly tetra fluoro ethylene (PTFE), tetrafluoroethylene-Hexafluoropropylene-copolymer (FEP) and tetrafluoroethylene-perfluoro(alkyl vinyl ether) copolymer (PFA).

4. The mold of claim 1, wherein each of the cavities has an uneven surface pattern formed on an inner surface thereof.

5. The mold of claim 1, wherein each of the cavities has a protrusion formed in a center of an inner surface thereof.

6. A method of manufacturing a light emitting diode package, the method comprising:
providing a substrate with a light emitting diode chip attached thereon;
providing a mold for forming a lens of the light emitting diode package, wherein one of the entirety of the mold and a portion of the mold including an inner surface of each of the cavities is formed of fluorocarbon resin to prevent the resin contained in the cavities from adhering to the mold;
seating the substrate on the mold and injecting a liquid resin, which is a material of the lens of the light emitting diode package, into the cavities of the mold; and
separating the mold from the resin, the material of the lens of the light emitting diode package, and from the substrate after the resin is cured.

7. The method of claim 6, wherein the mold is formed of a metallic material coated with fluorocarbon resin on one of the entire surface in which the cavities are formed and an inner surface of each of the cavities.

8. The method of claim 6, wherein the fluorocarbon resin is one selected from a group consisting of poly tetra fluoro ethylene (PTFE), tetrafluoroethylene-Hexafluoropropylene-copolymer (FEP) and tetrafluoroethylene-perfluoro(alkyl vinyl ether) copolymer (PFA).

9. The mold of claim 6, wherein each of the cavities has an uneven surface pattern formed on an inner surface thereof.

10. The method of claim 6, wherein each of the cavities has a protrusion formed in a center of an inner surface thereof.
